(19) United States
(12) Patent Application Publication
(10) Pub. No.: US 2024/0033552 A1
(43) Pub. Date: Feb. 1, 2024

(54) TANK FOR PRESSURIZED FLAMMABLE GAS

(71) Applicant: FAURECIA SYSTEMES D'ECHAPPEMENT, Nanterre (FR)

(72) Inventor: Ronan BOTELLA, CHEVREMONT (FR)

(21) Appl. No.: 18/226,825

(22) Filed: Jul. 27, 2023

(30) Foreign Application Priority Data
Jul. 29, 2022 (FR) 22 07848

(51) Int. Cl. A62C 35/02; F17C 13/12; A62C 35/10

(52) U.S. Cl. CPC A62C 35/023; F17C 13/12; A62C 35/10; F17C 2223/0107; F17C 2250/0439; F17C 2225/0107

(57) ABSTRACT

A tank for pressurized flammable gas, such as hydrogen, comprising at least one primary cylinder of pressurized flammable gas and at least one secondary cylinder of pressurized extinguishing gas. The at least one primary cylinder is individually equipped with a safety device that is capable of automatically releasing the flammable gas contained in said at least one primary cylinder toward the open air in the event of detection of an overheating situation of the at least one primary cylinder. The at least one secondary cylinder of pressurized extinguishing gas is fluidically connected with each safety device, and the safety device is configured to release extinguishing gas simultaneously with a release of flammable gas.

### CROSS-REFERENCE TO RELATED APPLICATION

This application is a U.S. non-provisional application claiming the benefit of French Application No. 22 07848, filed on Jul. 29, 2022, which is incorporated herein by reference in its entirety.

### TECHNICAL FIELD

The disclosure relates to a tank for pressurized flammable gas, such as hydrogen, preferentially a tank of the gas storage system (GSS) type.

### BACKGROUND

Such a tank is, in a known manner, equipped with at least one safety device capable of releasing the flammable gas outside the tank, into the open air, if overheating is detected. Indeed, under the effect of overheating near the tank, an overpressure occurs and it is possible to create an undesirable outburst. However, a release of flammable gas remains unwanted in that the released flammable gas can feed a potential flammable situation, which is a probable cause of the overheating.

Thus, an approach is sought to accompany the release of the flammable gas to increase safety and to prevent it from being able to feed a flammable source.

### SUMMARY

A tank for pressurized flammable gas, such as hydrogen, comprising: at least one primary cylinder of pressurized flammable gas, said at least one primary cylinder being individually equipped with a safety device that is capable of automatically releasing the flammable gas contained in said at least one primary cylinder toward the open air in the event of detection of an overheating situation of the at least one primary cylinder; and where the tank further comprises at least one secondary cylinder of pressurized extinguishing gas fluidically connected with each safety device, a safety device being configured to release extinguishing gas simultaneously with a release of flammable gas.

Particular features or embodiments, usable alone or in combination, are:
a safety device is configured to release a volume of extinguishing gas greater than the volume of flammable gas released,
a safety device is configured so that the ratio of the volume of extinguishing gas to the cumulative volume of flammable gas and of extinguishing gas is less than 8%, preferentially less than 4%,
the ratio of the volume of extinguishing gas to the cumulative volume of flammable gas and extinguishing gas is determined by the respective cross sections of the extinguishing gas and flammable gas supply ducts,
the tank comprises a single secondary cylinder,
the extinguishing gas is an inert gas, such as: nitrogen, argon, helium,
a safety device is able to mix flammable gas and extinguishing gas before releasing them,
a safety device comprises a detector feature that is able to detect overheating of a primary cylinder and a releaser feature that has a closed default position in which it closes off the flammable gas and extinguishing gas ducts and an open position in which it releases the flammable gas and extinguishing gas ducts, the passage into the open position being controlled by the detector feature,
the detector feature is combined with the releaser feature and comprises a fuse feature that closes the gas ducts and disintegrates in heat so as to free the flammable gas and extinguishing gas ducts,
the detector feature is distinct from the releaser feature and is able to control the releaser feature in the event of detection of overheating, and the releaser feature comprises at least one valve arranged through the flammable gas and extinguishing gas ducts, said at least one valve being closed by default.

### BRIEF DESCRIPTION OF THE DRAWINGS

The disclosure will be better understood on reading the following description, given solely by way of example, and with reference to the appended figures in which:

FIG. 1 shows, in schematic view, a tank, here a GSS;

FIG. 2 shows, in schematic view, the operation in the event of overheating;

FIG. 3 shows a security device according to a first embodiment;

FIG. 4 shows a security device according to a second embodiment; and

FIG. 5 shows a security device according to a third embodiment.

### DESCRIPTION OF THE EMBODIMENTS

The disclosure relates to a tank 1 for pressurized flammable gas. Such a tank 1, for example, comprises a tank for hydrogen. It may, for example, be intended to be installed on board a vehicle, the hydrogen being the fuel.

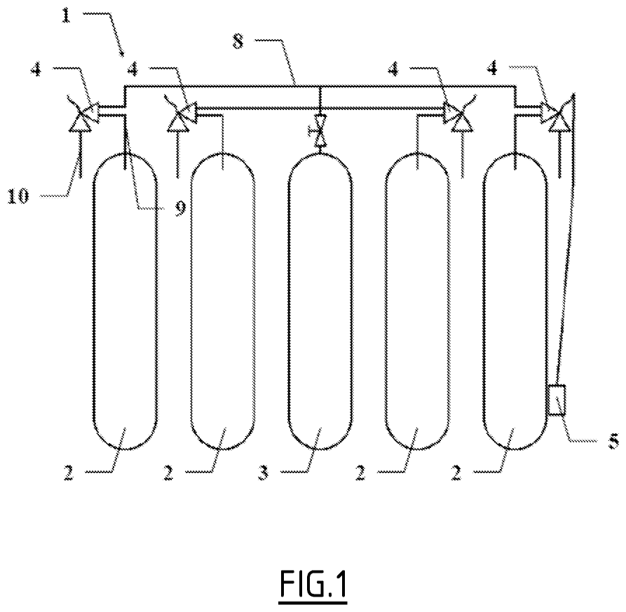

Such a tank 1 comprises at least one primary cylinder 2 of pressurized flammable gas. The tank 1 may comprise a single flammable gas cylinder 2. Preferentially, as shown in FIG. 1, the tank 1 is a tank 1 of the GSS type. A tank 1 of the GSS type is a tank 1 comprising a plurality of primary cylinders 2. These primary cylinders 2 are generally fluidically interconnected so as to evenly distribute the volume and pressure of gas stored between all the primary cylinders 2, which are arranged parallel to one another. A rail connector typically allows such an interconnection. The GSS tank 1 then substantially occupies the volume of a parallelepiped.

In the event of at least one primary cylinder 2 overheating, the pressure inside said primary cylinder 2 increases. If the overheating continues and no measurement is taken, there is a risk of an outburst of the overheated primary cylinder 2. This outburst is a critical event that it is desired to avoid. To this end, each primary cylinder 2 is individually equipped with a safety device 4. Such a safety device 4 is, in a known manner, able to automatically release the flammable gas contained in the primary cylinder 2 so as to allow it to escape into the open air. A duct 9 leads the flammable gas from the primary cylinder 2 to the safety device 4. A release duct 10, at the outlet of each safety device 4, allows the emission of the gas from the safety device 4 to the open air.

Such a release avoids the most critical event, which is the outburst of the primary cylinder 2. However, this release spreads the content of the primary cylinder 2, namely a flammable gas, in the environment. Now, if the primary cylinder 2 is heated, this means that there is a hot spot, or even an open flame source, near the primary cylinder 2. Thus, the flammable gas risks unfavorably feeding a flame source that has already started or even igniting in contact with the hot spot. Thus, this release solves a critical problem, but creates a secondary problem that is scarcely less serious.

The disclosure proposes to carry out a release of the flammable gas in the event of overheating or overpressure which does not pose the problem of risking possible inflammation of the released gas.

According to one feature, the tank 1 further comprises at least one secondary cylinder 3 of extinguishing gas. This extinguishing gas is stored under pressure in said at least one secondary cylinder 3. In the case of a GSS, said at least one secondary cylinder 3 advantageously takes the place of at least as many primary cylinders 2. However, it is not connected to the connection rail of the primary cylinders 2.

In addition, said at least one secondary cylinder 3 is fluidically connected, via at least one duct 8, with the inlet of each of the safety devices 4. A safety device 4 is configured to release extinguishing gas simultaneously with a release of flammable gas, namely in the event of detection of an overheating situation of the primary cylinder 2.

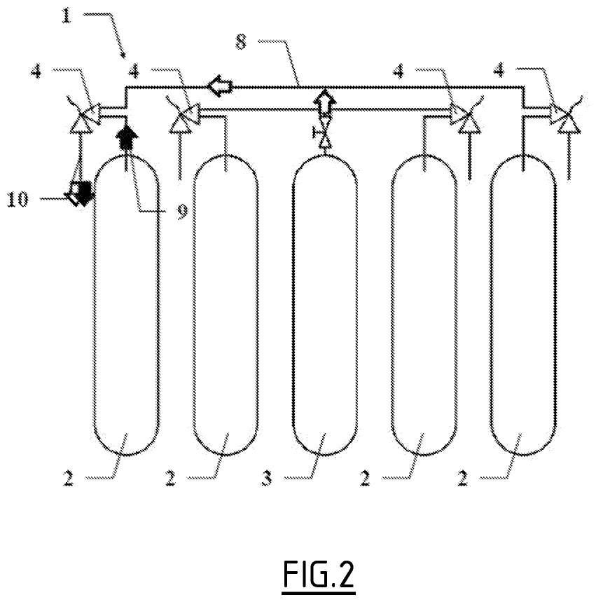

FIG. 2 shows such a release. Overheating is detected on the leftmost primary cylinder 2 of the figure. Thus, its safety device 4 is triggered and carries out a release of flammable gas from the primary cylinder 2, via the duct 9, complete with an extinguishing gas coming from the secondary cylinder 3, via the duct 8, and releases the two gases, flammable and extinguishing, into the open air via the release duct 10. The black arrows represent the flammable gas circulation, while the white arrows represent the extinguishing gas circulation.

Here, it is assumed that a single primary cylinder 2 is overheating. The release process, which is independent for each primary cylinder 2 due to the independence of each safety device 4, would similarly apply for each overheating primary cylinder 2. Due to the common distribution of extinguishing gas, the latter would be distributed between all the safety devices 4 as needed.

According to another feature, a safety device 4 is configured to release a volume of extinguishing gas greater than the volume of flammable gas released. This is at least necessary to guarantee and to meet conditions of non-auto-outburst or non-auto-ignition of the flammable gas.

According to another feature, a safety device 4 is configured so that the ratio of the volume of extinguishing gas to the cumulative volume of flammable gas and of extinguishing gas is less than 8%, preferentially less than 4%. V_{EX}/(V_{EX}+V_{IN})<8%, respectively 4%, with V_{EX} the volume of extinguishing gas and V_{IN} the volume of flammable gas.

According to another feature, the ratio of the volume of extinguishing gas to the cumulative volume of flammable gas and extinguishing gas is determined by the respective cross sections of the extinguishing gas and flammable gas supply ducts. Thus, if the volume of flammable gas must be half the volume of extinguishing gas, the flammable gas intake duct 9 is configured so as to have a half cross section of the cross section of the extinguishing gas intake duct 8.

In the case of a GSS, the tank 1 comprises a number of primary cylinders 2 connected to a connection rail. The number of secondary cylinders 3 may be any number. The greater it is, the more the safety increases, in that it is possible to secure the tank 1 for a longer time: the extinguishing gas is able to accompany a release of flammable gas and/or it is possible to secure the tank 1 more significantly, the flow rate of extinguishing gas released also increasing with the number of overheating primary cylinders 2. In contrast, dedicating a secondary cylinder 3 to the storage of extinguishing gas reduces the useful storage capacity, namely the flammable gas storage capacity. Thus, a compromise must be found between useful storage capacity and safety.

According to another feature, favoring useful capacity, the tank 1 comprises a single secondary cylinder 3.

The extinguishing gas may be any product, solid, liquid or gaseous, limiting or delaying combustion. According to another feature, the extinguishing gas is an inert gas, such as: nitrogen, argon, helium.

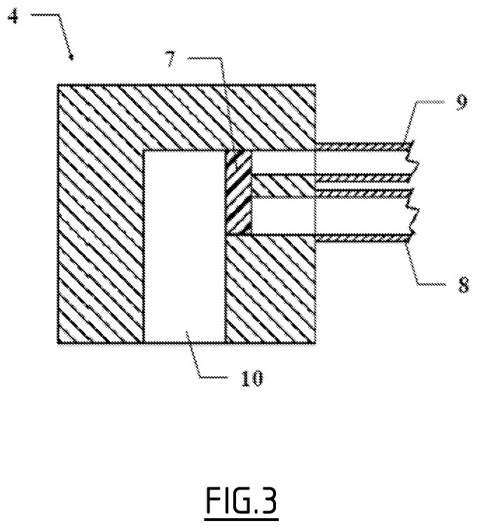

It has been described that the extinguishing gas was released at the same time as the flammable gas when overheating is detected. In order to better limit the risks of ignition of the released flammable gas, it is advantageous for the flammable gas to be released mixed with the extinguishing gas. Thus, according to another feature, a safety device 4 is able to mix flammable gas and extinguishing gas before releasing them. This is illustrated later, in relation to FIGS. 3-5, with three embodiments of a safety device 4.

In general, a safety device 4 comprises a detector feature 5 and a releaser feature 6. The detector feature 5 is able to detect overheating of its primary cylinder 2. The releaser feature 6 comprises a closed position in which it closes off the gas ducts and an open position in which it frees the gas ducts. The closed position is the initial position and the default position. When it detects overheating, the detector feature 5 controls the releaser feature 6 to switch to the open position.

According to a first embodiment, more particularly shown in FIG. 3, the detector feature 5 is combined with the releaser feature 6. The safety device 4 in this case comprises only a fuse feature 7. This fuse feature 7 initially blocks the two gas ducts at the inlet: the flammable gas duct 9 and the extinguishing gas duct 8. It thus ensures the function of the releaser feature 6 in the closed position. The fuse feature 7 also ensures the function of the detector feature 5 in that, during overheating, its constitution is such that the fuse feature disintegrates. In doing so, it then ensures the function of the releaser feature 6 in the open position, freeing the passage for the gases, which, under pressure, then circulate toward the release duct 10. This duct 10 also acts as a chamber for mixing the two gases, flammable and extinguishing, before their release.

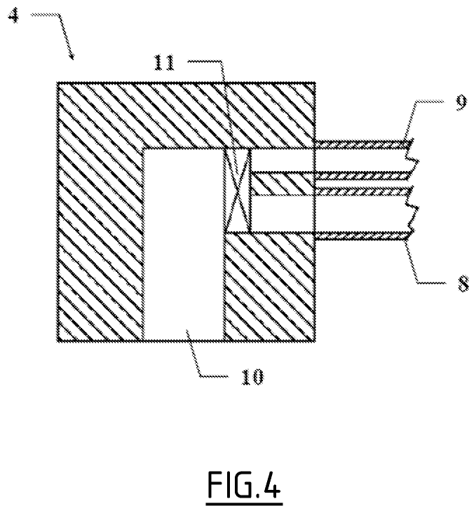

According to another embodiment, more particularly shown in FIG. 4, the detector feature 5 is separate from the releaser feature 6. In this case, the detector feature 5 is able to control the releaser feature 6 if overheating is detected. In this case, the releaser feature 6 may, for example, comprise a valve 11 arranged simultaneously through the gas ducts 8, 9. This valve 11 is initially closed and is closed by default. The detector feature 5, in the event of overheating, is able to control the opening of the valve 11.

This other embodiment advantageously allows the detection to be offset at a point different from the safety device 4, for example the other end of the primary cylinder 2. This is, for example, shown in FIG. 1, for the rightmost primary cylinder 2, with a detector feature 5 arranged at the end of the primary cylinder 2 opposite the one accommodating its safety device 4.

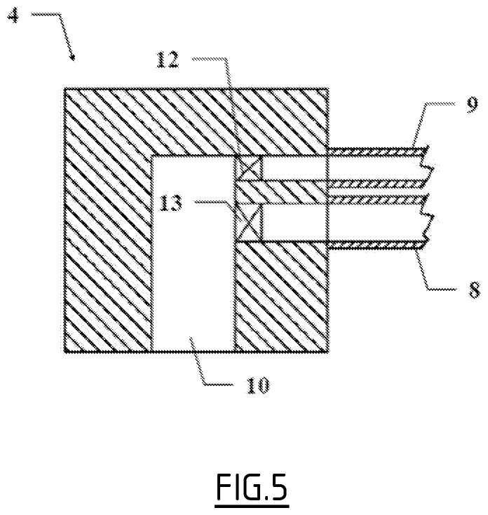

FIG. 5 shows a variant of the embodiment of FIG. 4. In the safety device 4 of FIG. 4, a single valve 11 simultaneously closes off the extinguishing gas duct 8 and the flammable gas duct 9. Alternatively, in the safety device 4 of FIG. 5, the single valve 11 is replaced by a valve 12 closing off the flammable gas duct 9 and by a valve 13 closing off the extinguishing gas duct 8. The operation is identical to that described for the safety device 4 of FIG. 4. The two valves 12-13 are initially closed and are closed by default. The detector feature 5, in the event of overheating, is able to control the simultaneous opening of the valve 12 and the valve 13.

The disclosure has been shown and described in detail in the drawings and the preceding description. This must be considered as illustrative and given by way of example and not as limiting the disclosure to this only description. Many alternative embodiments are possible.

### LIST OF REFERENCE SIGNS

1: tank
2: primary cylinder,
3: secondary cylinder,
4: safety device,
5: detector feature,
6: releaser feature,
7: fuse feature,
8: extinguishing gas duct,
9: flammable gas duct,
10: release duct,
11-13: valve.

1. A tank for pressurized flammable gas, comprising:
at least one primary cylinder of pressurized flammable gas, each primary cylinder being individually equipped with a safety device that is capable of automatically releasing the pressurized flammable gas in said at least one primary cylinder toward open air in an event of detection of an overheating situation of the at least one primary cylinder; and
at least one secondary cylinder of pressurized extinguishing gas fluidically connected with each safety device, at least one of the safety devices being configured to release extinguishing gas simultaneously with a release of pressurized flammable gas.

2. The tank according to claim 1, wherein at least one of the safety devices is configured to release a volume of pressurized extinguishing gas greater than a volume of flammable gas released.

3. The tank according to claim 1, wherein at least one of the safety devices is configured so that a ratio of a volume of pressurized extinguishing gas to a cumulative volume of pressurized flammable gas and of pressurized extinguishing gas is less than 8%.

4. The tank according to claim 1, wherein at least one of the safety devices is configured so that a ratio of a volume of pressurized extinguishing gas to a cumulative volume of pressurized flammable gas and of pressurized extinguishing gas is less than 4%.

5. The tank according to claim 1, wherein a ratio of a volume of pressurized extinguishing gas to a cumulative volume of pressurized flammable gas and pressurized extinguishing gas is determined by respective cross sections of extinguishing gas and flammable gas supply ducts.

6. The tank according to claim 1, wherein the at least one secondary cylinder comprises a single secondary cylinder.

7. The tank according to claim 1, wherein the pressurized extinguishing gas is an inert gas.

8. The tank according to claim 7, wherein the inert gas is chosen among: nitrogen, argon or helium.

9. The tank according to claim 1, wherein at least one of the safety devices is able to mix pressurized flammable gas and pressurized extinguishing gas before releasing the pressurized flammable gas and pressurized extinguishing gas.

10. The tank according to claim 5, wherein at least one of the safety devices comprises a detector feature that is able to detect overheating of a corresponding primary cylinder and a releaser feature that has a closed default position in which the flammable gas and extinguishing gas ducts are closed off and an open position in which the flammable gas and extinguishing gas ducts are opened, a passage into the open position being controlled by the detector feature.

11. The tank according to claim 10, wherein the detector feature is combined with the releaser feature and comprises a fuse feature that closes off the flammable gas and extinguishing gas ducts and disintegrates in heat to free the flammable gas and extinguishing gas ducts.

12. The tank according to claim 10, wherein the detector feature is distinct from the releaser feature and is able to control the releaser feature in an event of detection of overheating, and the releaser feature comprises at least one valve arranged through the flammable gas and extinguishing gas ducts, said at least one valve being closed by default.
